(19) United States
(12) Patent Application Publication
(10) Pub. No.: US 2026/0352989 A1
(43) Pub. Date: Nov. 5, 2026

(54) SINGLE-AXIS VIBRATION TRANSDUCER

(71) Applicant: AAC ACOUSTIC TECHNOLOGIES (SHENZHEN) CO., LTD., Shenzhen (CN)

(72) Inventor: Jinyu Zhang, Shenzhen (CN)

(21) Appl. No.: 19/295,739

(22) Filed: Aug. 11, 2025

Related U.S. Application Data
(63) Continuation of application No. PCT/CN2025/092441, filed on Apr. 30, 2025.

(51) Int. Cl. H04R 1/08; H04R 1/02; H04R 3/00

(52) U.S. Cl. CPC H04R 1/08; H04R 1/02; H04R 3/00

(57) ABSTRACT

The present disclosure discloses a single-axis vibration transducer including a housing, a circuit board, a microphone, and a vibration detection assembly mounted on the circuit board. The vibration detection assembly includes a first elastic member deform along a vibration direction, a first mass block suspended in a second receiving cavity via an end of the first elastic member away from the circuit board along the vibration direction, and an elastic sealing ring sandwiched between the circuit board and the first mass block; a sealing cavity is provided on the elastic sealing ring by penetrating thereon along the vibration direction, a through hole is provided on the circuit board by penetrating thereon along the vibration direction, the through hole is communicated with the sealing cavity, the through hole is wholly covered by the microphone. The single-axis vibration transducer in the present disclosure has lower cost, lower noise and higher sensitivity.

### FIELD OF THE PRESENT DISCLOSURE

The present disclosure relates to transducer technologies, especially relates to a single-axis vibration transducer applied in portable mobile terminals.

### DESCRIPTION OF RELATED ART

Traditional microphone with sound hole is applied for external vibration signal detection in vehicles. However, it is hard for such traditional microphone to maintain high detection accuracy and reliability under severe environment such as high pressure car wash, condensation, frost, and dust. However, vibration transducer without holes may effectively avoid said environmental. As a result, accelerometer is increasingly used in vehicles to capture vibration signals.

In related art, the noise and the bandwidth of the accelerometer are mutually constrained. To achieve lower noise, the bandwidth has to be compressed within 1 kHz, which cannot meet the low noise requirements in a wider bandwidth. Besides, accelerometer is not only expensive, but also has complex configurations and high background noise.

Therefore, it is necessary to provide an improved single-axis vibration transducer to overcome the problems mentioned above.

### SUMMARY OF THE INVENTION

One object of the present disclosure is to provide a single-axis vibration transducer with lower cost, lower noise and higher sensitivity.

The single-axis vibration transducer includes a housing having a receiving space; a circuit board mounted on the housing, dividing the receiving space into a first receiving cavity and a second receiving cavity isolated from each other; a microphone mounted on the circuit board and located inside the first receiving cavity; and a vibration detection assembly mounted on the circuit board and located inside the second receiving cavity, including a first elastic member mounted on the circuit board and configured to deform along a vibration direction; a first mass block suspended in the second receiving cavity via an end of the first elastic member away from the circuit board along the vibration direction; and an elastic sealing ring sandwiched between the circuit board and the first mass block; wherein a sealing cavity is provided on the elastic sealing ring by penetrating thereon along the vibration direction, a through hole is provided on the circuit board by penetrating thereon along the vibration direction, the through hole is communicated with the sealing cavity, the through hole is wholly covered by the microphone.

As an improvement, a projection of the through hole along the vibration direction is located inside the sealing cavity.

As an improvement, a geometry center of the elastic sealing ring is overlapped with a geometry center of the first mass block.

As an improvement, vibration detection assembly further includes a second elastic member fixed to a surface of the first mass block away from the first elastic member; the second elastic member is sandwiched between the first mass block and the housing.

As an improvement, the vibration detection assembly includes at least two first elastic members spaced apart from each other, each of the at least two first elastic members is in a bar shape.

As an improvement, the vibration detection assembly includes at least two second elastic members spaced apart from each other, each of the at least two second elastic members is in a bar shape.

As an improvement, each of the at least two first elastic members is opposite to a respective one of the at least two second elastic members along the vibration direction.

As an improvement, the housing includes a protrusion protruded inwardly from a surface facing the receiving space; the circuit board is fixed on the protrusion.

As an improvement, further including an electrical connector including one end inside the receiving space electrically connected with the circuit board and the other end outside the housing electrically connected with an external circuit board.

As an improvement, the housing further includes a side wall protruded outwardly from a surface away from the receiving space, an accommodation space is enclosed by the side wall; the end of the electrical connector outside the housing is received in the accommodation space.

### BRIEF DESCRIPTION OF THE DRAWINGS

The present disclosure will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiment described hereby is only to explain this disclosure, not intended to limit this disclosure.

FIG. 1 is an isometric view of a single-axis vibration transducer in accordance with an exemplary embodiment of the present disclosure.

FIG. 2 is an exploded view of the single-axis vibration transducer in FIG. 1.

FIG. 3 is a cross-sectional view of the single-axis vibration transducer taken along line A-A in FIG. 1.

FIG. 4 is a cross-sectional view of the single-axis vibration transducer taken along line B-B in FIG. 1.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

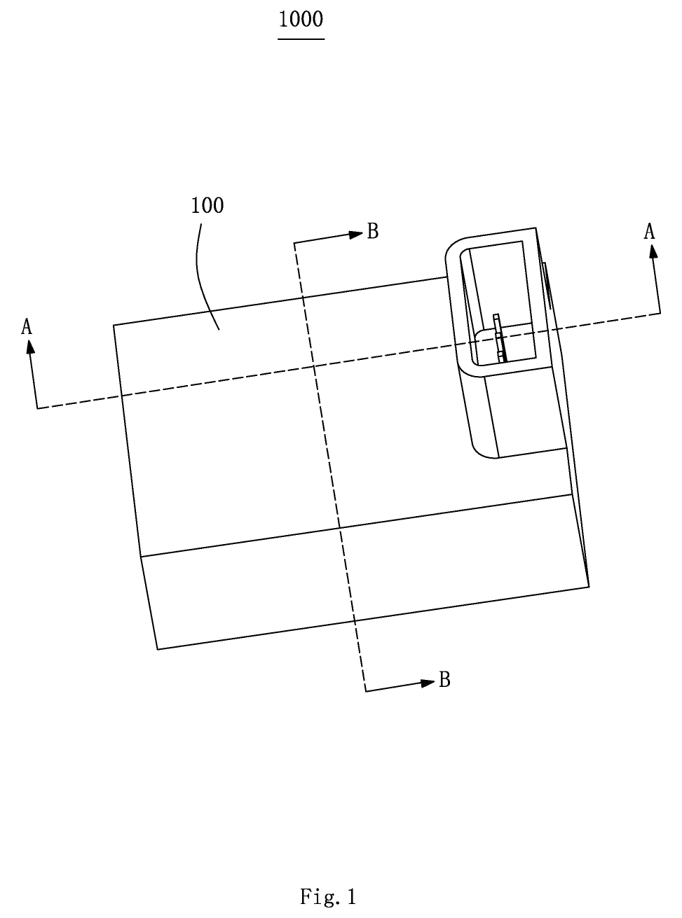

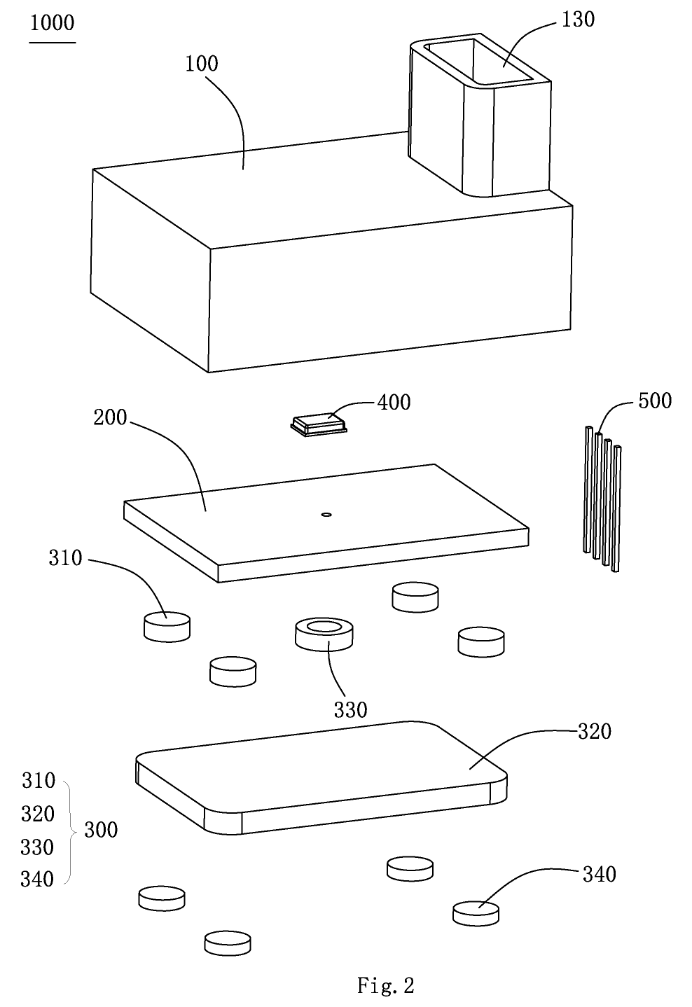

Please refer to FIGS. 1-2 together, a single-axis vibration transducer 1000 provided by an exemplary embodiment of the present disclosure includes a housing 100 with a receiving space 110, a circuit board 200 received in the receiving space 110, a vibration detection assembly 300 mounted on the circuit board 200, and a microphone 400. The circuit board 200 is mounted on the housing 100 to divide the receiving space 110 into a first receiving cavity 111 and a second receiving cavity 112 isolated from each other. Specifically, the microphone 400 is located inside the first receiving cavity 111, and the vibration detection assembly 300 is located inside the second receiving cavity 112.

To be specific, the vibration detection assembly 300 includes a first elastic member 310 mounted on the circuit board 200 and configured to deform along a vibration direction, a first mass block 320 suspended in the second receiving cavity 112 via an end of the first elastic member 310 away from the circuit board 200 along the vibration direction, and an elastic sealing ring 330 sandwiched between the circuit board 200 and the first mass block 320.

Moreover, a sealing cavity 331 is provided on the elastic sealing ring 330 by penetrating thereon along the vibration direction. A through hole 210 is provided on the circuit board 200 by penetrating thereon along the vibration direction. The through hole 210 is communicated with the sealing cavity 331, and the through hole 210 is wholly covered by the microphone 400. When the vibration detection assembly 300 detects external vibration, the first mass block 320 vibrates along the vibration direction guided by the first elastic member 310. Simultaneously, the elastic sealing ring 330 deforms along the vibration direction, therefore compressing or stretching the air in the sealing cavity 331 along with the reciprocation of the first mass block 320. In this manner, the air pressure variation in the sealing cavity 331 is transmitted to the microphone 400 via the through hole 210. The microphone 400 is sensitive to respond to air pressure variation even as low as 1 mPa. Besides, the microphone 400 has low noise which is beneficial to detect clear vibration signal. It should be understood that the microphone 400 in the present disclosure could be MEMS microphone or piezoelectric microphone. The specific structure of the microphone 400 is not limited. Compared with present accelerator chip, the microphone 400 has lower cost, and better low noise performance under a bandwidth at least 20 kHz.

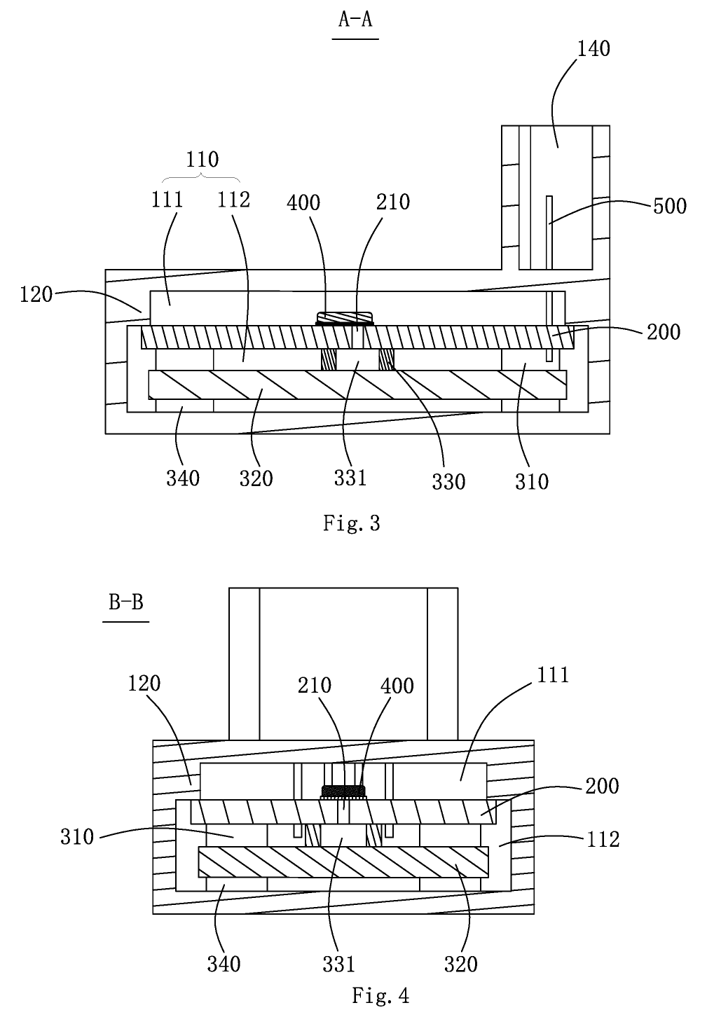

As shown in FIGS. 3-4, a projection of the through hole 210 along the vibration direction is located inside the sealing cavity 331.

For further improving the sensitivity of the single-axis transducer 1000, the vibration detection assembly 300 further includes a second elastic member 340 fixed to a surface of the first mass block 320 away from the first elastic member 310. The second elastic member 340 is sandwiched between the first mass block 320 and the housing 100, thus improving the fixation strength of the vibration detection assembly 300 and the reliability of the single-axis transducer 1000. It should be understood that the first mass block 320 is spaced apart from the housing 100.

Additionally, the vibration detection assembly 300 includes at least two first elastic members 310 spaced apart from each other, and at least two second elastic members 340 spaced apart from each other. Each of the at least two first elastic members 310 is in a bar shape. Similarly, each of the at least two second elastic members 340 is also in a bar shape. A number of the first elastic member 320 and a number of the second elastic member 340 is equal. Thus, each of the at least two first elastic members 310 is opposite to a respective one of the at least two second elastic members 340 along the vibration direction. In one embodiment, the first mass block 320 is rectangular. The number of the first elastic member 320 and the second elastic member 340 is both four. Therefore, the four first elastic members 320 and the four second elastic members 340 are arranged at respective corner portion of the rectangular first mass block 320.

The first elastic member 320 and the second elastic member 340 are both made of rubber material.

In order to improve the sensitivity of the single-axis transducer 1000, a geometry center of the elastic sealing ring 330 is overlapped with a geometry center of the first mass block 320.

The housing 100 includes a protrusion 120 protruded inwardly from a surface facing the receiving space 100. The circuit board 200 is fixed on the protrusion 120.

Furthermore, the single-axis transducer 1000 includes an electrical connector 500 including one end inside the receiving space 110 electrically connected with the circuit board 200 and the other end outside the housing 100 electrically connected with an external circuit board. Besides, the housing 100 further includes a side wall 130 protruded outwardly from a surface away from the receiving space 110. An accommodation space 140 is enclosed by the side wall 130. The end of the electrical connector 500 outside the housing 100 is received in the accommodation space 140.

Compared with the related art, the single-axis vibration transducer in the present disclosure includes a first mass block vibrate along with external vibration guided by the first elastic member. Thus, the air in the sealing cavity of the elastic sealing ring is accordingly compressed or stretched along the reciprocation of the first mass block. Therefore, the air pressure signal generated in the sealing cavity is transmitted to the microphone via the through hole on the circuit board. In this manner, not only reduce the cost of the single-axis transducer, but also effectively improve the sensitivity of the single-axis transducer for achieving low noise requirement under larger bandwidth.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A single-axis vibration transducer comprising:
a housing having a receiving space;
a circuit board mounted on the housing, dividing the receiving space into a first receiving cavity and a second receiving cavity isolated from each other;
a microphone mounted on the circuit board and located inside the first receiving cavity; and
a vibration detection assembly mounted on the circuit board and located inside the second receiving cavity, comprising:
a first elastic member mounted on the circuit board and configured to deform along a vibration direction;
a first mass block suspended in the second receiving cavity via an end of the first elastic member away from the circuit board along the vibration direction; and
an elastic sealing ring sandwiched between the circuit board and the first mass block; wherein
a sealing cavity is provided on the elastic sealing ring by penetrating thereon along the vibration direction, a through hole is provided on the circuit board by penetrating thereon along the vibration direction, the through hole is communicated with the sealing cavity, the through hole is wholly covered by the microphone.

2. The single-axis vibration transducer as described in claim 1, wherein a projection of the through hole along the vibration direction is located inside the sealing cavity.

3. The single-axis vibration transducer as described in claim 1, wherein a geometry center of the elastic sealing ring is overlapped with a geometry center of the first mass block.

4. The single-axis vibration transducer as described in claim 1, wherein vibration detection assembly further comprises a second elastic member fixed to a surface of the first mass block away from the first elastic member, the second elastic member is sandwiched between the first mass block and the housing.

5. The single-axis vibration transducer as described in claim 4, wherein the vibration detection assembly comprises at least two first elastic members spaced apart from each other, each of the at least two first elastic members is in a bar shape.

6. The single-axis vibration transducer as described in claim 5, wherein the vibration detection assembly comprises at least two second elastic members spaced apart from each other, each of the at least two second elastic members is in a bar shape.

7. The single-axis vibration transducer as described in claim 6, wherein each of the at least two first elastic members is opposite to a respective one of the at least two second elastic members along the vibration direction.

8. The single-axis vibration transducer as described in claim 1, wherein the housing comprises a protrusion protruded inwardly from a surface facing the receiving space; the circuit board is fixed on the protrusion.

9. The single-axis vibration transducer as described in claim 1, further comprising an electrical connector including one end inside the receiving space electrically connected with the circuit board and the other end outside the housing electrically connected with an external circuit board.

10. The single-axis vibration transducer as described in claim 9, wherein the housing further comprises a side wall protruded outwardly from a surface away from the receiving space; an accommodation space is enclosed by the side wall; the end of the electrical connector outside the housing is received in the accommodation space.
